(19) United States
(12) Patent Application Publication
(10) Pub. No.: US 2017/0031583 A1
(43) Pub. Date: Feb. 2, 2017

(54) ADAPTIVE USER INTERFACE

(71) Applicant: YOOSHR, LTD., London (GB)

(72) Inventors: Philippe LEVIEUX, London (GB); Nicholas PELLING, London (GB)

(21) Appl. No.: 15/226,613

(22) Filed: Aug. 2, 2016

Related U.S. Application Data
(60) Provisional application No. 62/200,052, filed on Aug. 2, 2015.

(51) Int. Cl. G06F 3/0484; G06F 3/0488; H04N 5/265; G06T 3/00; H04N 5/225; G06T 7/40; G06K 9/62; G06K 9/46; G06F 3/0482; H04N 5/232

(52) U.S. Cl. CPC G06F 3/04847; G06F 3/0482; G06F 3/04883; G06F 3/04886; H04N 5/265; H04N 5/23293; H04N 5/2256; G06T 7/408; G06K 9/6215; G06K 9/4661; G06K 9/4652; G06T 3/0093; G06F 2203/04804

(57) ABSTRACT

A method is provided that includes receiving digital content to be displayed on a display device; and in response to a trigger event, modifying the digital content, and providing the modified digital content to the display device.

The present application claims the benefit of priority under 35 USC 119(e) based on U.S. provisional patent application No. 62/200,052, filed on Aug. 2, 2015, the contents of which is incorporated herein in its entirety by reference.

### BACKGROUND

Field

Aspects of the example implementations relate to a user interface element that is configured to be adapted or changed, depending on a given set of parameters.

Related Background

In the related art, a user interface (UI) can be a passive element such as the background of an online mobile application (e.g., “app”), or UI elements that change their color gradient because of a parameter. The UI element can be animated, and the transition between states can be discrete or continuous.

Related art software user interfaces are static. Additional commercial resources are being allocated to user interface development, user experience optimization and human interaction design for software products. Despite the increased investment and importance of user interface design, related art technical innovation in the field has been minimal.

The related art user interface is comprised of static elements which are laid out in a specific way to optimize interactions by the user. In some cases, the user can change the position of UI elements. Some user interfaces can be customized by adding or moving element such as favorite, shortcut icon, widget, online application icon, etc. Menu elements can be added or removed. Related art user interfaces can be resized or adapted depending on screen-size and device orientation. Localization and language change is a common related art way to customize an interface.

Related art software may offer the user the ability to change the background color, font-color, font-size etc. used in the interface to enhance the readability and scope for user customization. Related art software may offer a default configuration and layout depending on what the user will be using the software for (e.g., drawing vs photo editing preset in software dedicated to graphic design).

Most of the above describe related art customizations listed above are primarily available on software for laptop and desktop computer. However, in the mobile application market, the level of user interface customization made available to users is extremely minimal. It may be said that level of customization available to the user decreases with the size of the device view screen—the smaller the screen, the less customization is enabled. For example, in related art GPS and camera devices, they all increasingly have in built touch-enabled view screens but allow no customization by the user of the user interface, apart from localization.

### SUMMARY

Aspects of the example implementations relate to systems and methods associated with the way user interfaces can be designed to impact user experience.

More specifically, example implementations are provided that may widen the opportunities for user interface customization, not necessarily directly by allowing the user to customize the interface, but by allowing the interface to adapt and customize itself based on external variable factors and thereby impacting (e.g., enhancing) user experience while reducing the need for direct user input.

According to an example implementation, a computer-implemented method is provided. The method includes

The methods are implemented using one or more computing devices and/or systems.

The methods may be stored in computer-readable media.

### BRIEF DESCRIPTION OF THE DRAWINGS

FIG. 1 shows a user interface indicative of a first process according a first example implementation.

FIG. 2 shows an example flow for the adaptive background according to an example implementation associated with a computer program.

FIG. 3 illustrates and example implementation on a mobile device that is running software to display the camera feed full-screen.

FIG. 4 shows an example flow for an adaptive UI according to an example implementation.

FIG. 5 shows images of an example user interface displaying a picture or a camera feed.

FIG. 6 shows a diagram for an example implementation showing how the distortion would be calculated.

FIG. 7 shows an example environment suitable for some example implementations.

FIG. 8 shows an example computing environment with an example computing device suitable for use in some example implementations.

### DETAILED DESCRIPTION

The subject matter described herein is taught by way of example implementations.

Various details have been omitted for the sake of clarity and to avoid obscuring the subject matter. The examples shown below are directed to structures and functions for implementing systems and methods for exchange of information between users.

According to an example implementation, an adaptive background is provided that enables the presentation of additional meaning and context to the user. An adaptive background can be presented in many ways; in one example implementation, the full screen background of the user interface changes, animating smoothly depending on the user's action, behavior or other external factors.

According to a first example implementation, a background of a calculator program for an application is provided. In this example implementation, a calculator program is disclosed, and the calculator program is one that would be known to those skilled in the art. However, the example implementation is not limited to calculator program, and any other type of program or application, including an online application, may be substituted therefor without departing from the inventive scope. For example, but not by way of limitation, any software program or computer application having a display background may be substituted for the calculator program.

In this example implementation, the background may be animated according to a color spectrum where negative numbers are shown against a cold blue color, changing to a warmer red color when the result of the current calculus has a positive numerical value. This has the benefit of giving additional context to the online mobile application especially when the changes are done in real-time through smooth and seamless transition.

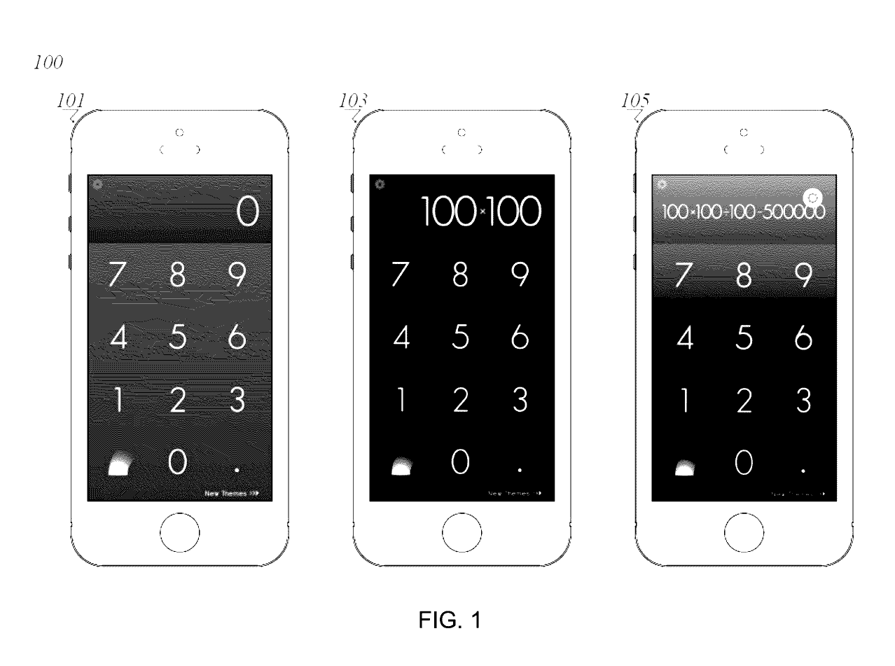

FIG. 1 provides an example implementation 100 directed to a calculator application with an adaptive background. On the left at 101, neutral is represented by a mid-grey tone. In the middle at 103, a positive result makes the background gradient animate to a much lighter color. On the right at 105, the result has a negative value, and the background becomes darker. While the foregoing colors and functions have been disclosed, the present example implementation is not limited thereto, and other colors, or other triggering events that may result in the changing of the colors, may be substituted therefor without departing from the inventive scope. Further, the action is not limited to colors, and may instead be directed to other changes in the way they display is provided to a user, other than color.

This adaptation impacts the user experience by bringing more visual context to the calculator. For example but not by way of limitation, this example implementation may be useful particularly for a child who is learning to calculate.

As explained above, the use of an online calculator is illustrative only, and the example implementation is not limited to the scope. The parameter used to adapt the user interface element need not be solely based on user input. The parameter could be related to GPS coordinates, gyroscope data, temperature data, time or any other data not in the user's direct control, or other parameters that may impact a function, and made us impact how information is presented to the user, as would be understood by those skilled in the art.

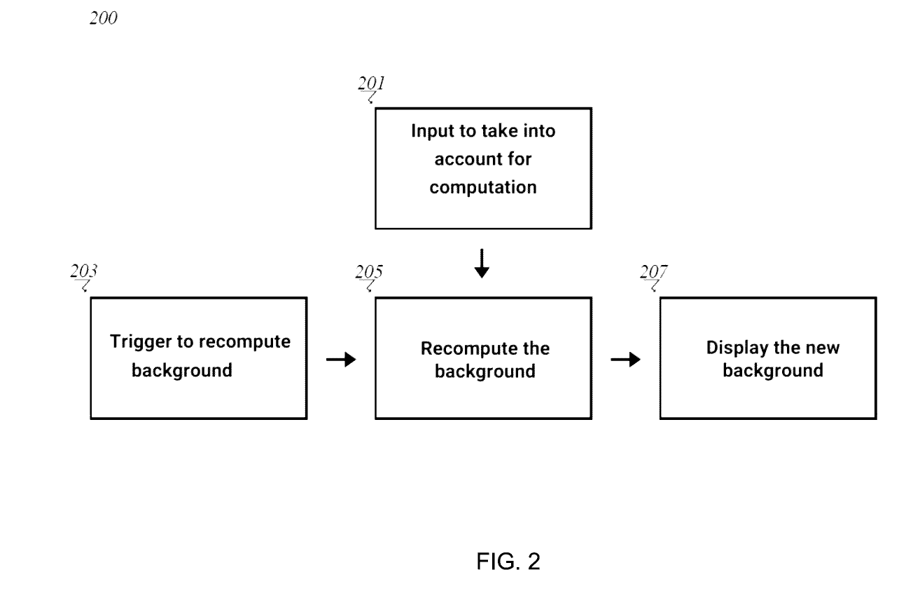

FIG. 2 shows a flow 200 for the adaptive background according to an example implementation associated with a computer program including instructions executed on a processor, the instructions being stored on a storage. According to this flow, a trigger is provided for the recomputation. For example, the trigger may be a listener or a user action, but is not limited thereto. In addition to being associated with a user or user-defined event, the trigger may also be related to a timer, e.g. compute the adaptive background 30 times per seconds. When the background recomputes, it might need additional input such as time, weather information, or information from the actual trigger. Once recomputed, it can be displayed which might involve an animation. Further, the trigger may also be an external trigger such as the temperature of a room (e.g., recorded by a sensor) that goes up once a threshold has been reached.

For example, but not by way of limitation, the example implementations may include a temperature sensor positioned on a device. The temperature sensor may sense, using a sensing device, the ambient temperature of the environment. Alternatively, a non-ambient temperature may be recorded as well.

Further, once the ambient temperature is sensed, it is provided to the application. The application compares the received information of the ambient temperature to a previous or baseline temperature measurement. The previous or baseline temperature measurement may be higher, lower or the same as the current temperature measurement. If the temperature measurement is the same, then the appearance of the UI may not change.

However, if the temperature measurement is determined to not be the same as the previous temperature information, this result may serve as a trigger to generate an action. The action may be, for example, a change in the background of the UI. For example, but not by way of limitation, if the temperature of the room has increased or decreased, the color, design, image, or other visual indicia on the background of the application is modified. The change in the background image that occurs based on the trigger may be modified based on a user preference (e.g., a user may choose colors, icons associated with favorite characters or teams, or other visual indicator that can be defined by a range of preference.

As shown in FIG. 2, for a program that is currently in operation, an input 201 may be provided, such as the user entering a number on the calculator in the example of FIG. 1. As explained above, the trigger 203 may be provided based on a user action, a sensed condition, and automated process such as a timer, or other content. Based on the original content of the input 201 as well as the trigger 203, and action 205 are performed. In this case, the action is to recompute the color of the background based on the result of the calculation. At 207, a display associated with the action 205 is provided to the user, such as a background of the calculator having a different color associated with the result of the calculation, which was based on the input from the user.

Another example implementation relates to online applications or platforms that show a camera feed in full-screen mode. This is increasingly relevant on mobile devices, as their inbuilt cameras improve with advances in CPU (central processing unit) and GPU (graphics processing unit) processing power and camera technology. The majority of social apps, networks and platforms integrate a camera view of some sort. It is usually necessary to overlay UI elements on the camera view to enable users to interact.

However, the example implementations are not limited to a camera, and other implementations may be substituted therefor. For example, the foregoing example implementations may be applied when the content of an image is displayed on the screen, and the image can be static, a frame of a video/live-photo or a frame from the camera.

Common examples of UI elements that are overlaid on the camera view provided by the camera feed include but are not limited to buttons to change the flash settings, rotate the camera view (front/back), apply a filter and to capture a photo or video. If a button of a single color is used, in some situations, the button will be fully or partially blending with the camera background when displaying the same or a similar color, making “readability” an issue for the user. Related art approaches to the problem of making UI buttons distinctive over a camera view include, but are not limited to:

the use for UI elements of a color that rarely occurs in the natural world such as a bright purple (for example, such a color might be less likely to appear in the camera feed)

the use of contrast color background behind the UI element

the use of a border or a drop shadow around the UI element

Further, while the example implementation refers to a UI element including a selectable object that includes a button, any other selectable object as known to those skilled in the art may be substituted therefor without departing from the inventive scope. For example, but not by way of limitation, the UI element may be a radio button, a slider, a label, a checkbox, segment control, or other selectable object.

The example implementations associated with the present inventive concept are directed to a smarter approach that improves the user experience and opens up new possibilities in user interface design. In one example implementation, a UI element is displayed with a plain color on top of the camera view in real-time. A number of pixels are sampled from the camera view underneath the UI element and using those data points, the average color is determined in real-time. Using that color as a baseline, for example, it is possible to calculate the average brightness or luminance underneath that particular UI element and adapt the UI elements color in real-time to render the UI element distinct from the background scene on the camera view. The luminance of a RGB pixel may be calculated according to the following formula:

Y=0.2126 R+0.7152 G+0.0722 B

However, in some example implementations, such as the images that come from the camera of a iOS device, it may be possible to request them in YUV color space. The information contained in the Y plane may be directly used for the luminance without any extra computation.

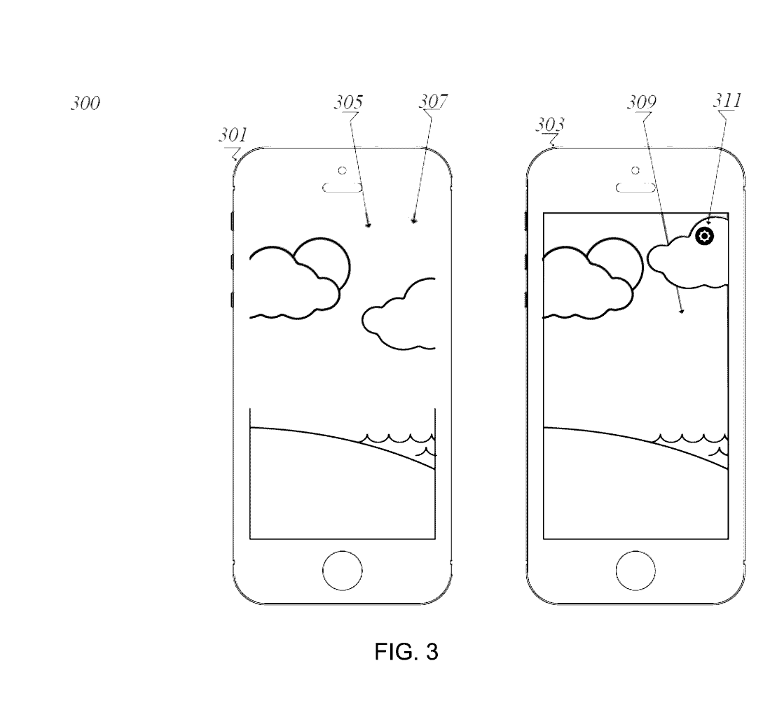

FIG. 3 illustrates and example implementation 300 on a mobile device that is running software to display the camera feed full-screen. Two views from the same device having the same camera and operating the same online application are generated 301, 303, at a first time T and a second time T+x, respectively, are shown with the mobile device having the camera feed in a full-screen mode. In the first view 301, an area of the camera feed 305 underlies a UI element 307. Because the area of the camera feed underlying the UI element 305 is dark in contrast to the UI element 307, a user can recognize the presence of the UI element 305. On the other hand, in the second view 303, it is noted that a cloud has appeared in the camera feed 309 that underlies the UI element 311. According to the example implementation, a color of the UI element 311 has been modified to contrast the area of the camera feed 309 that underlies the UI element 311.

In this example implementation, the UI element 307, 311 is a button (e.g., adaptive settings button) located in the upper right-hand corner. The background color of the button is adapting depending on the luminance behind it. In this manner, the button is always visible to the user against the background scene, providing an improved user experience and guaranteed readability in all scenarios with no requirement for active user input or customization.

According to an aspect of the example implementation it may be possible for the user to customize the interface. Alternatively, allowing the interface to adapt and customize itself based on external variable factors may impact (e g , enhance) user experience while at the same time reducing the need for direct user input.

In one example implementation, the user interface element color may be filtrated to give the user a smooth transition and avoid violent shifts in the appearance of the user interface. Conversely, in other example implementations such as for example in an automotive head-up display, sudden easily perceptible shifts in the user interface may be beneficial.

In some example implementations, grouping UI elements together may be required. For example, if a plurality of (e.g., two) buttons are located next to each other, it is necessary to sample the background underneath these adjacent UI elements only once. This approach may have various advantages; firstly it may save processing power, and secondly both UI elements may be rendered in the same style for a more uniform user experience.

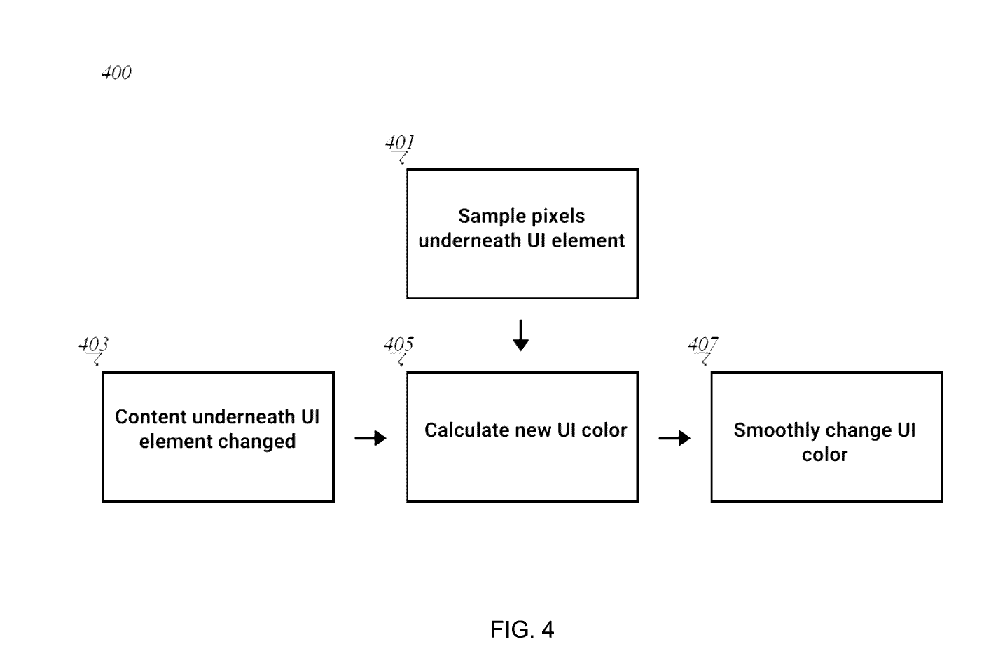

FIG. 4 shows an example flow 400 for this kind of adaptive UI according to an example implementation. The computation may be triggered by a trigger event, such as, but not limited to, the content underneath the element changing. This would be the case each time a new camera frame is being displayed. A subset of color underneath the UI element is sampled and used to calculate the new color or look-and-feel for the UI element. Once calculated, the change can be applied. This might involve an animation.

For example, at 401, the system samples pixels in an area that is underneath the UI element. At 403, a triggering event occurs, such as a change in the content in the area underneath the UI element. Based on this triggering event, at 405 the system calculates a new color for the UI element, and at 407, the UI color is smoothly changed on the display. While the foregoing elements of flow referred to a change in color, the example implementations are not limited thereto, and other changes to the user experience and/or user interface may be substituted for color, as would be understood by those skilled in the art.

According to an aspect of the example implementations, adaptive UI may improve the user experience, such as making the user experience more immersive.

According to yet another example implementation, a representation of the user interface providing a display on a device, including the UI object, is generated.

When a user touches or performs a gesture on a user-interface, the user may be provided with some form of feedback. For example, after receiving user input, a user interface object such as a button may adopt a different state: up, down, highlighted, selected, disabled, enabled etc., each state being represented by different graphics. This enables the user to see which state the element is in; e.g. a button will go from an “up” state to a “down” state when touched by the user.

For a full-screen view displaying the camera, providing appropriate user feedback when the user interacts with the display device, such as a touch action or applying a gesture, can impact the user experience. Many related art applications do not provide such feedback.

While the foregoing example implementation may be implemented this for a full screen camera view, the present implementations are not limited thereto. For example, but not by way of limitation, this system may be used in a post-processing editor which allows the user to edit photo/live-photo/video which fits the screen, while maintaining their original aspect-ratio. Accordingly, the example implementations are not limited to the camera.

On the other hand, some related art applications may display a radial gradient or a tinted view that appears underneath the immediate location of the user interaction, such as underneath a finger of the user. However, these related art techniques may have various problems and disadvantages. For example, but not by way of limitation, these related art techniques deliver a poor user experience as they detract from the immersive experience given by the camera stream, thus disrupting from the visual display in the full camera mode.

The example implementations provide a user interface element that is part of the full screen camera view, such as underneath the finger of the user. When a user interaction with the display device such as a touch is initiated by the user, the view underneath the finger of the user is warped in a manner that gives a 3-dimensional (3D) perspective. In one example implementation, one can imagine a 3-D distortion or “bulge” smoothly appearing underneath the user's finger warping the content of the view. In other example implementations, any sort of warping can be applied: swirl, sphere, concave, convex etc. To emphasize the warping, a color tint or gradient tint can be added to the warping itself. The warping can be animated or not, and will follow the user's finger smoothly across the screen wherever the user's finger moves in a seamless manner.

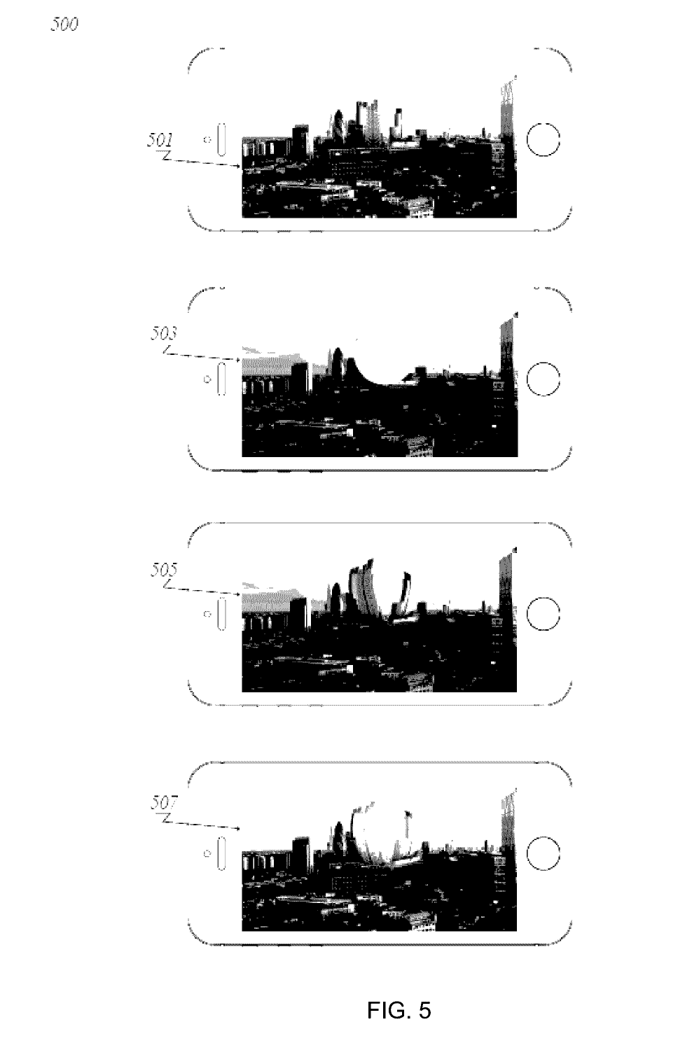

FIG. 5 shows images 500 of a user interface displaying a picture or a camera feed of a London landscape. In each of the images 500, the user is touching the screen at the same position in between the skyscrapers. In the top image 501, no visual feedback is given to the user. In the second image 503, a circular semi-transparent circle is shown below the user's finger. In the third image 505, the interactive adaptive user-interface according to the example implementation, shown as a distortion such as a bulge in the present disclosure, is used underneath the user's finger. While this might be unclear in the figure, when applied in real-time using smooth and seamless animation, this artifact increases the user experience while keeping full context over the view underneath the finger. In the last image, a radial gradient is overlaid on top of the distortion to emphasize the touched area.

According to the example implementation, the bulge may appear anywhere on the surface of the user interface (e.g., screen). For example, this may be proximal to the button, or distant from the button.

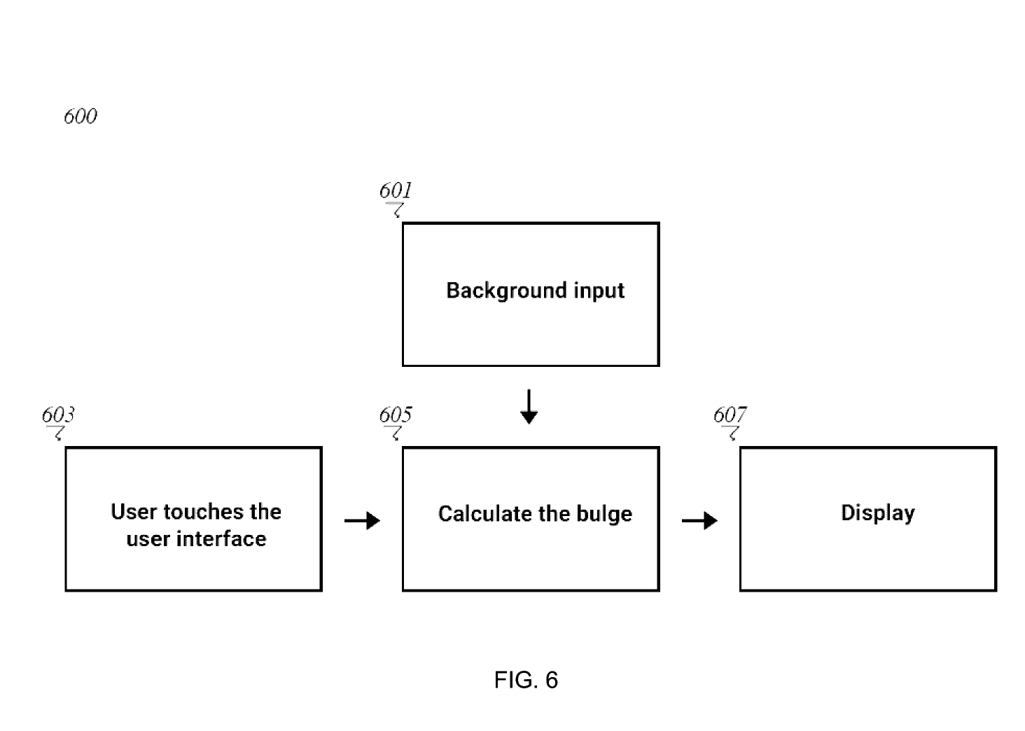

FIG. 6 shows a diagram 600 for example implementation showing how the distortion would be calculated according to an example implementation. Whenever the user has a finger on the screen, the view underneath the user's finger vicinity is sampled and used to calculate the distortion and then displayed. When the user takes their finger off the screen, the distortion fades out smoothly. The re-computation of the distortion occurs whenever the user moves their finger and whenever the content of the background is changing.

As shown in the flow of the diagram 600 for the example implementation, with respect to a display device having a camera feed in full-screen mode, a background input is provided 601. More specifically, the background input may include, but is not limited to, a camera feed that receives or senses and input from a camera sensor. Receivers or inputs may be provided that are different from a camera, without departing from the inventive scope.

At 603, a user interacts with the user interface. More specifically, the user may interact by touch, gesture or other interactive means as would be understood by those skilled in the art, to indicate an interaction between the user and the user interface on the display. The interaction of 603 is fed back into the system, and a bulge (e.g., distortion) that distorts the camera feed at the location where the user has interacted with the user interface is calculated at 605. At 607, a display of the display device is updated to include the distortion. As noted above the distortion may also include other effects, such as a radial gradient.

Foregoing example implementations may be used on any sort of device with a viewing screen, whether physical or projected. It can be applied on native application, mobile or desktop and web-based applications. The example implementations can be applied to streamed content, in a live environment or through post-processing. The software can be native, online, distributed, embedded, etc.

According to the example implementations, the computation can be done in real time, or can be deferred. The computation can be done on the CPU or on the GPU using technology such as WebGL or OpenGL. However the example limitations are not limited thereto, and other technical approaches may be substituted therefor without departing from the inventive scope. Further, when rendered on the GPU, the entire screen including the user interface is fed to the GPU as one large texture, the GPU can then distort the texture using fragment/vertex shaders. The output texture is then rendered on screen. This can be seen as a 2-pass rendering, which is different from the related art user interface rendering, which is done in one pass. Doing a second-pass over the entire screen is computationally more expensive, to achieve real-time rendering on a mobile device, this rendering is done on the GPU. While OpenGL was originally developed for gaming, it has been derived and used in image processing and in this example, it is used to enhance and create a unique user interface.

It is important to render all user-interface elements in a first full-screen texture before applying the distortion. This way, the user interface elements can also be distorted, creating a fully seamless experience. If the user-interface elements were rendered as normal on-top of the distortion, it may look and feel awkward.

One technique that can be applied to some use-case to speed up rendering is to fade-out the user-interface element when the distortion is being showed. Only the background gets distorted and cycles are saved by not rendering each user-interface element independently.

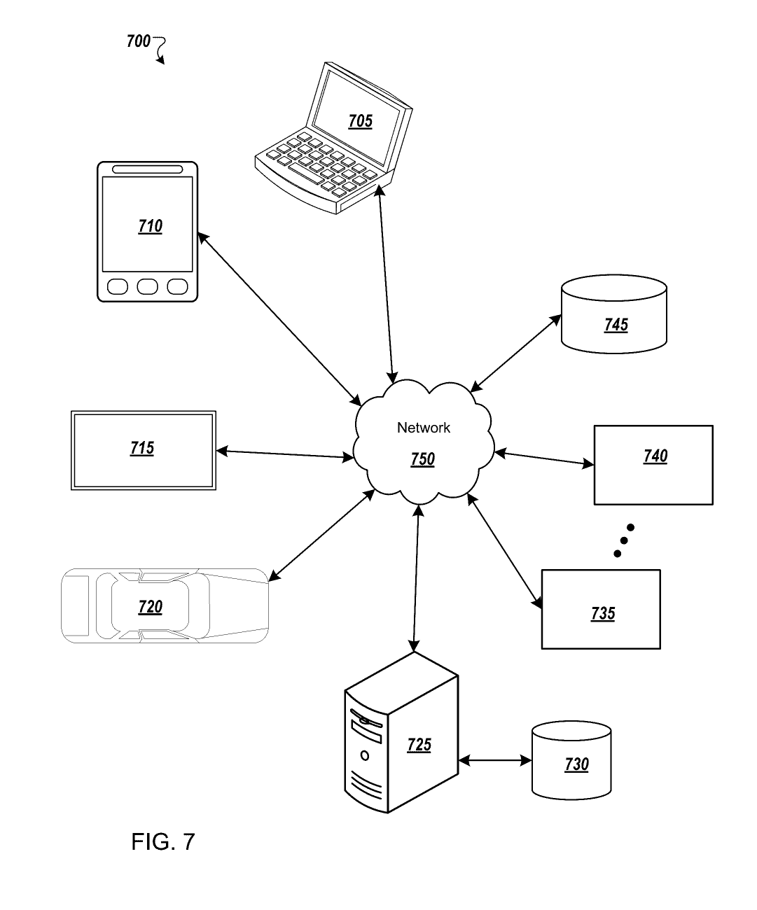

FIG. 7 shows an example environment suitable for some example implementations. Environment 700 includes devices 705-745, and each is communicatively connected to at least one other device via, for example, network 760 (e.g., by wired and/or wireless connections). Some devices may be communicatively connected to one or more storage devices 730 and 745.

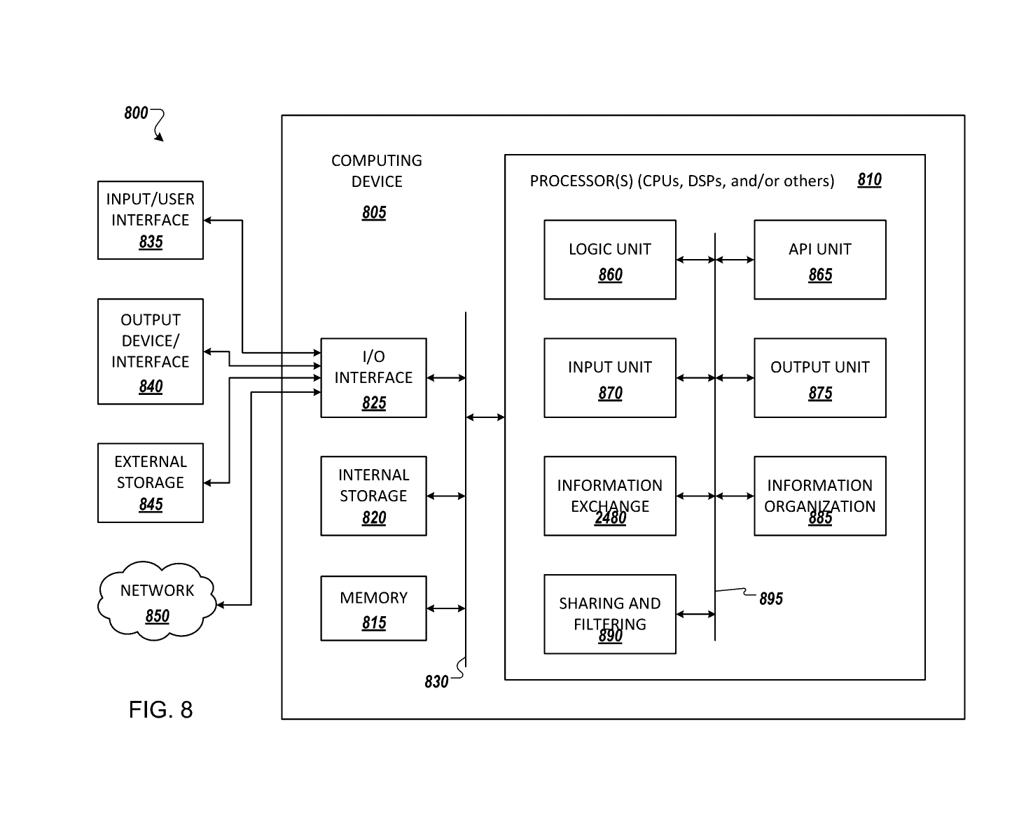

An example of one or more devices 705-745 may be computing device 805 described below in FIG. 8. Devices 705-745 may include, but are not limited to, a computer 705 (e.g., a laptop computing device), a mobile device 710 (e.g., smartphone or tablet), a television 715, a device associated with a vehicle 720, a server computer 725, computing devices 735-740, storage devices 730 and 745.

In some implementations, devices 705-720 may be considered user devices, such as devices used by users. Devices 725-745 may be devices associated with service providers (e.g., used by service providers to provide services and/or store data, such as webpages, text, text portions, images, image portions, audios, audio segments, videos, video segments, and/or information thereabout).

For example, a user may access, view, and/or share content related to the foregoing example implementations using user device 710 via one or more devices 725-745. Device 710 may be running an application that implements information exchange, calculation/determination, and display generation.

FIG. 8 shows an example computing environment with an example computing device suitable for use in some example implementations. Computing device 805 in computing environment 800 can include one or more processing units, cores, or processors 810, memory 815 (e.g., RAM, ROM, and/or the like), internal storage 820 (e.g., magnetic, optical, solid state storage, and/or organic), and/or I/O interface 825, any of which can be coupled on a communication mechanism or bus 830 for communicating information or embedded in the computing device 805.

Computing device 805 can be communicatively coupled to input/user interface 835 and output device/interface 840. Either one or both of input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 840 may include a display, television, monitor, printer, speaker, braille, or the like. In some example implementations, input/user interface 835 and output device/interface 840 can be embedded with or physically coupled to the computing device 805. In other example implementations, other computing devices may function as or provide the functions of input/user interface 835 and output device/interface 840 for a computing device 805.

Examples of computing device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions, Smart-TV, with one or more processors embedded therein and/or coupled thereto, radios, and the like), as well as other devices designed for mobility (e.g., “wearable devices” such as glasses, jewelry, and watches).

Computing device 805 can be communicatively coupled (e.g., via I/O interface 825) to external storage 845 and network 850 for communicating with any number of networked components, devices, and systems, including one or more computing devices of the same or different configuration. Computing device 805 or any connected computing device can be functioning as, providing services of, or referred to as a server, client, thin server, general machine, special-purpose machine, or another label.

I/O interface 825 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computing device 805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, Objective-C, Swift, and others).

Processor(s) 810 can execute under any operating system (OS) (not shown), in a native or virtual environment. One or more applications can be deployed that include logic unit 860, application programming interface (API) unit 865, input unit 870, output unit 875, input processing unit 880, calculation/determination unit 885, output generation unit 890, and inter-unit communication mechanism 895 for the different units to communicate with each other, with the OS, and with other applications (not shown). For example, input processing unit 880, calculation/determination unit 885, and output generation unit 890 may implement one or more processes described and shown in FIGS. 1-8. The described units and elements can be varied in design, function, configuration, or implementation and are not limited to the descriptions provided.

In some example implementations, when information or an execution instruction is received by API unit 865, it may be communicated to one or more other units (e.g., logic unit 860, input unit 870, output unit 875, input processing unit 880, calculation/determination unit 885, and output generation unit 890). For example, after input unit 870 has received a user input according to any of FIGS. 1-6, output generation 890 provides an updated output (e.g., display) to the user based on the result of the calculation/determination unit 885, such as in response to a trigger action. The models may be generated by actions processing 885 based on machine learning, for example. Input unit 870 may then provide input from a user related to an interaction with the display or user interface, or an input of information. Output unit 875 then generates the output to the user interface of the display.

In some instances, logic unit 860 may be configured to control the information flow among the units and direct the services provided by API unit 865, input unit 870, output unit 875, input processing unit 880, calculation/determination unit 885, and output generation unit 890 in some example implementations described above. For example, the flow of one or more processes or implementations may be controlled by logic unit 860 alone or in conjunction with API unit 865.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A computer-implemented method, comprising:
receiving digital content to be displayed on a display device; and
in response to a trigger event, modifying the digital content, and providing the modified digital content to the display device.

2. The computer implemented method of claim 1, wherein the trigger event comprises at least one of a user action and an external trigger.

3. The computer implemented method of claim 1, where in the trigger event comprises an automated timer.

4. The computer implemented method of claim 1, wherein the modifying comprises providing additional digital content to the user, or changing an appearance of the digital content on the display device.

5. The computer implemented method of claim 1, wherein the digital content is received from an input for display.

6. The computer implemented method of claim 5, wherein the modified digital content is an overlay on the camera feed.

7. The computer implemented method of claim 6, wherein the overlay is a selectable object that performs an action in response to an input from a user.

8. The computer implemented method of claim 7, wherein the object comprises at least one button.

9. The computer implemented method of claim 8, wherein the at least one button comprises a plurality of buttons commonly grouped such that the modifying is commonly performed for each of the plurality of buttons.

10. The computer implemented method of claim 7, wherein the action comprises at least one of setting a value of a flash associated with the camera, rotating a view of the camera, and providing a filter for the camera.

11. The computer implemented method of claim 6, wherein a display parameter of the overlay is determined based on a value of a corresponding display parameter of the camera feed located under the overlay.

12. The computer implemented method of claim 11, wherein the display parameter comprises color, and further comprising calculating at least one of a brightness and a luminance of the portion of the camera feed under the overlay in real time, and rendering the overlay in another color that is distinct from the color of the camera feed that is positioned under the overlay.

13. The computer implement it method of claim 12, further comprising:
sampling pixels of the camera feed positioned under the overlay;
comparing the sample pixels to the overlay to determine a difference in at least one of the brightness and the luminance;
for the difference not exceeding a threshold, calculating the another color that is distinct from the color of the pixels of the camera feed under the overlay; and
transitioning from the color to the another color for the overlay.

14. The computer implemented method of claim 11, wherein the display parameter is determined based on at one of user input and automatically.

15. The computer implemented method of claim 1, wherein the trigger event comprises a user input that includes at least one of a touch and a gesture.

16. The computer implemented method of claim 7, wherein the object comprises a button having a shape that corresponds to a region of the display device at which a touch or a gesture is sensed.

17. The computer implemented method of claim 7, wherein the object is one of semitransparent, and transparent with a modification to a region of the camera feed corresponding to the shape of the object and the location of the object, wherein the object is a shape that corresponds to a region of the display device formed in response to a sensed touch or a gesture.

18. The computer implemented method of claim 17, wherein for the object being transparent, the modification comprises positioning at least one of a distortion at a position of the camera feed that is under the object and associated with the shape of the object, and the distortion having a radial gradient at the position of the camera feed that is under the object and associated with the shape of the object.

19. The computer implemented method of claim 18, wherein the positioning the distortion is determined by:
sampling the pixels of the camera feed under the button that is transparent;
generating a distortion of the sample pixels that comprises the distortion, in response to the user input; and
fading the bulge in response to the user input being discontinued.
